(19) United States
(12) Patent Application Publication
(10) Pub. No.: US 2025/0114826 A1
(43) Pub. Date: Apr. 10, 2025

(54) INDUSTRIAL CLEANING MACHINE FOR CLEANING PARTS, IN PARTICULAR SPRAY GUNS AND ACCESSORIES THEREOF

(71) Applicant: TECHNOFOX INTERNATIONAL SÀRL, Sion (CH)

(72) Inventor: Cédric Rey, Sion (CH)

(21) Appl. No.: 18/836,072

(22) PCT Filed: Feb. 6, 2023
(86) PCT No.: PCT/IB2023/051051

§ 371 Date: Aug. 6, 2024

(30) Foreign Application Priority Data
Feb. 7, 2022 (EP) 22155502.2

(51) Int. Cl. B08B 3/02; B05B 15/555; B08B 3/00

(52) U.S. Cl. CPC B08B 3/028; B05B 15/555; B08B 3/006; B08B 2203/027

(57) ABSTRACT

An industrial cleaning machine for cleaning parts, in particular spray guns and accessories thereof, including a cleaning chamber for receiving parts, and a pneumatically operated cleaning system capable of subjecting the parts to a cleaning operation using a cleaning liquid. The cleaning system includes at least one pneumatically actuated pump that is operated by compressed air supplied to the cleaning machine to pump and supply the cleaning liquid from a container. The cleaning machine integrates a control device configured to monitor and control operation of the cleaning machine and to operate autonomously on power provided by a battery. The control device is configured to gather status information relating to operation of the cleaning machine and communicate the status information to a remote server. The control device includes an air circuit configured to be coupled to an air compressor to control supply of the compressed air to the pneumatically actuated pump.

### TECHNICAL FIELD

The present invention generally relates to an industrial cleaning machine for cleaning parts, in particular spray guns and accessories thereof.

### BACKGROUND OF THE INVENTION

European Patent No. EP 0 991 481 B1 and U.S. Pat. No. 6,361,617 B1, which both derive from International (PCT) Application No. WO 99/01230 A1, disclose a method and device for cleaning objects, namely, spray guns. During cleaning operations, one or more spray guns to be cleaned is/are located within a dedicated cleaning chamber comprising one or more cleaning nozzles which are positioned such that they discharge a suitable cleaning liquid (such as a solvent) to clean each spray gun externally and/or internally until all paint residues adhering thereto on the outside and/or inside of the spray gun have been removed. The cleaning device disclosed in EP 0 991 481 B1/U.S. Pat. No. 6,361,617 B1 comprises one or more pneumatically actuated pumps that are each operated by means of a supply of pressurized air to pump cleaning liquid from an associated cleaning liquid container and generate a pulsating flow of cleaning liquid that is supplied to the relevant cleaning nozzles through a supply conduit to perform cleaning of each spray gun. A return conduit is provided to recirculate the cleaning liquid from the cleaning chamber back to the cleaning liquid container. According to EP 0 991 481 B1/U.S. Pat. No. 6,361,617 B1, a pulse counting device is provided to start counting pulses of the pulsating flow of cleaning liquid being fed to the cleaning nozzles through the supply conduit and to automatically interrupt the pump, and thus the cleaning process, once a determined number of pulses has been counted by the pulse counting device. This solution provides a certain level of control on the execution of the cleaning process in that it ensures that cleaning cycles each corresponding to a given number of pulses are executed.

U.S. Pat. No. 5,954,070 A discloses an industrial cleaning machine for cleaning parts comprising a cleaning space capable of receiving one or more parts requiring cleaning, and a pneumatically operated cleaning system capable of subjecting the one or more parts to a cleaning operation using a cleaning liquid, the pneumatically operated cleaning system including a pair of pneumatically actuated pumps that are each operated by compressed air supplied to the cleaning machine to pump and supply the cleaning liquid from associated cleaning liquid containers. A pair of concentration measuring devices are further provided in respective fluid communication with first and second application conduits for measuring the concentration of the cleaning liquid passing therethrough, as pumped and supplied by the associated pumps. The relevant concentration measuring devices are preferably operated autonomously on power provided by batteries to avoid reliance on external electrical power. As such, the concentration measuring devices are merely designed to sense concentration of the cleaning liquids flowing through the application conduits and are not configured to control or monitor operation of the associated pumps.

Korean Patent No. KR 10 2122399 B1 discloses an ultrasonic cleaner that is provided with an IoT system to gather status information relating to operation of the ultrasonic cleaner and allow communication of such status information to a remote server.

U.S. Patent Publication No. US 2018/0264729 A1 discloses a machine for removing substrate material, for washing and for drying parts produced by a 3D printer. The machine is provided with an electronic enclosure containing electronics and processors for controlling operation of the machine. Such control system may include transmitters and receivers for remote connectivity with building automation systems or the like.

U.S. Patent Publication No. US 2017/0120303 A1 discloses a waterblasting system including a fluid supply device, an air supply device, and a waterblast tool. The fluid supply device is operated to deliver a fluid under pressure to the waterblast tool, while the air supply device is operated to supply compressed air to the waterblast tool. A controller is further provided to monitor and control operation of the fluid supply device and the air supply device via a wired or wireless connection. In one embodiment, the air supply device comprises an alternator that receives compressed air delivered form an air compressor to produce electrical energy that may be used to recharge a battery of the air supply device.

U.S. Patent Publication No. US 2009/0159102 A1 discloses an industrial cleaning machine that may be provided with remote monitoring capabilities.

Washing/cleaning machines for cleaning spray guns are commercially available on the market, for instance from company B-TEC GmbH (www.btecsystems.de). Such washing/cleaning machines typically make use of one or more air operated diaphragm pumps that are resistant to the various chemicals used as cleaning liquid. Cleaning liquid can be pumped by a first pump and supplied from and recirculated back to a first cleaning liquid container, while fresh/pure cleaning liquid can be pumped by a second pump and supplied from (without recirculation) a second cleaning liquid container.

Advantageously, during the cleaning process, each spray gun may be connected to a pressurized air supply to pressurize the spray gun and maintain a certain level of air pressure in the air circuit of the spray gun, and thereby ensure that no liquid residue can enter the interior of the air circuit of the spray gun.

One major constraint of the existing cleaning machines for cleaning spray guns resides in the fact that these machines typically need to be compliant with relevant safety requirements, including the so-called ATEX directives (in particular EU Directive 2014/34/EU, also referred to as the “ATEX 114 Directive”) governing the requirements for equipment intended to be used in potentially explosive atmospheres, such as paint workshops. Typically, cleaning machines are installed as standalone workplaces without any connection to the outside world, and it is up to the relevant end users to ensure that the cleaning machines are operated in compliance with relevant operating requirements and in accordance with the manufacturer's specifications, instructions and recommendations.

### SUMMARY OF THE INVENTION

A general aim of the present invention is to provide an improved cleaning machine which obviates the limitations of the known cleaning machines.

More specifically, an aim of the invention is to provide an industrial cleaning machine that ensures that manufacturer's specifications, instructions and recommendations are appropriately applied in practice.

Furthermore, an aim of the present invention is to provide an industrial cleaning machine that can reliably be operated and maintained.

Yet another aim of the invention is to provide such a solution that is cost-efficient to implement and run.

A further aim of the invention is to provide such a solution that can adequately control and ensure proper operation of the cleaning machine, and allow the end user to be adequately notified when changes or preventive maintenance operations need to be carried out.

These aims and others are achieved thanks to the solutions defined in the claims.

In accordance with a first aspect of the invention, there is accordingly provided an industrial cleaning machine for cleaning parts, in particular spray guns and accessories thereof, the features of which are recited in claim 1, namely, such an industrial cleaning machine comprising at least one cleaning chamber capable of receiving one or more parts requiring cleaning, and a pneumatically actuated cleaning system capable of subjecting the one or more parts to a cleaning operation using a cleaning liquid. The pneumatically operated cleaning system includes at least one pneumatically actuated pump that is operated by compressed air supplied to the cleaning machine to pump and supply the cleaning liquid from a cleaning liquid container. The cleaning machine integrates a control device configured to monitor and control operation of the cleaning machine and to operate autonomously on power provided by a battery. According to this first aspect of the invention, the control device is configured to gather status information relating to operation of the cleaning machine and communicate the status information to a remote server. Furthermore, the control device includes an air circuit that is configured to be coupled to an air compressor to control supply of the compressed air to the at least one pneumatically actuated pump.

Advantageous and/or preferred embodiments of the cleaning machine in accordance with the aforementioned first aspect of the invention form the subject-matter of dependent claims 2 to 9.

More specifically, the status information preferably includes operational parameters of the cleaning machine and of the control device, in particular a number of cleaning cycles performed by the cleaning machine, a start time of each cleaning cycle performed by the cleaning machine, a duration of each cleaning cycle performed by the cleaning machine, a number of parts subjected to the cleaning operation, a consumption of the cleaning liquid, pressure parameters measured by the control device, environmental parameters measured by the control device, and/or warning or error messages generated by the control device.

The control device preferably includes a transceiver configured to wirelessly communicate the status information to the remote server, in particular a transceiver operating according to the LPWAN (low-power wide area network) radio technology standard, such as the NB-IoT (Narrow-Band Internet of Things) standard. Even more preferably, the transceiver is further configured to receive data from the remote server to update operational settings of the cleaning machine and/or of the control device.

The control device may further include a geolocalization device to provide a geolocalization of the cleaning machine, in which case the status information communicated to the remote server includes the geolocalization of the cleaning machine. Geolocalization may be achieved by the provision of any suitable geolocalization technology, including satellite geolocalization and radio triangulation.

The control device may also include a sensor to measure the quality of air in the environment of the cleaning machine, in particular the presence of volatile organic compounds (VOC) in the environment of the cleaning machine. In such case, the status information communicated to the remote server may include environmental data relating to the quality of air measured in the environment of the cleaning machine. Alternatively or additionally, such environmental data may be displayed to the end user.

By the same token, the control device may include a temperature sensor to measure the temperature of the environment of the cleaning machine. In such case, the status information communicated to the remote server may include environmental data relating to the measured temperature of the environment of the cleaning machine.

The aforementioned environmental data may be useful in assessing whether the cleaning machine is operated under normal operating conditions and, as far the measurement of the presence of volatile organic compounds (VOC) is concerned, whether the cleaning machine is operated within acceptable environmental conditions to prevent any potentially harmful exposure of the end user.

The control device may also include one or more dedicated sensors and/or one or more sensor interfaces for connection to a corresponding number of dedicated sensors to measure operational parameters of the cleaning machine. In particular, dedicated pressure sensors could be provided to measure pressure of compressed air supplied to the cleaning machine or to components of the cleaning machine. Similarly, dedicated flow rate sensors could be provided to measure a flow rate of the cleaning liquid supplied by the pneumatically operated cleaning system. Dedicated gauge sensors could likewise be provided to measure a quantity of the cleaning liquid, such as the quantity of cleaning liquid being present in a cleaning liquid container from which the cleaning liquid is supplied.

In accordance with a particularly preferred embodiment of the invention, the battery is rechargeable by means of a turbine generator that forms part of the air circuit and is operated by the compressed air supplied to the cleaning machine. This particular aspect in effect forms a second aspect of the invention that is applicable independently of the aforementioned first aspect of the invention, namely, whether or not the control device is configured to gather status information relating to operation of the cleaning machine and communicate such status information to a remote server.

In other words, in accordance with a second aspect of the invention, there is also provided an industrial cleaning machine for cleaning parts, in particular spray guns and accessories thereof, the features of which are recited in independent claim 10, namely, such an industrial cleaning machine comprising at least one cleaning chamber capable of receiving one or more parts requiring cleaning, and a pneumatically operated cleaning system capable of subjecting the one or more parts to a cleaning operation using a cleaning liquid. The pneumatically operated cleaning system includes at least one pneumatically actuated pump that is operated by compressed air supplied to the cleaning machine to pump and supply the cleaning liquid from a cleaning liquid container. The cleaning machine integrates a control device configured to monitor and control operation of the cleaning machine and to operate autonomously on power provided by a battery. According to this second aspect of the invention, the control device includes an air circuit that is configured to be coupled to an air compressor to control supply of the compressed air to the at least one pneumatically actuated pump. Furthermore, the battery is rechargeable by means of a turbine generator that forms part of the air circuit and is operated by the compressed air supplied to the cleaning machine.

Advantageous and/or preferred embodiments of the cleaning machine in accordance with the aforementioned first and second aspects of the invention form the subject-matter of dependent claims 11 to 19.

More specifically, the control device may especially be configured to automatically switch to a low power consumption standby mode when no compressed air is supplied to the cleaning machine and to automatically switch to an operative mode when compressed air is supplied to the cleaning machine. In that context, the control device may further be configured to periodically wake up from the low power consumption standby mode to check a charge status of the battery. In such case, the control device may furthermore be configured to generate a warning or error message in case a charge status of the battery drops below a defined threshold and/or to force supply of compressed air to the turbine generator in case a charge status of the battery drops below the defined threshold.

In accordance with a particularly advantageous embodiment of the invention, the air circuit includes an inlet pressure regulator to regulate inlet pressure of the compressed air at an inlet of the air circuit and a first actuatable valve to control supply of compressed air to the at least one pneumatically actuated pump.

In this latter context, considering the particular application of the invention to the cleaning of one or more spray guns, the air circuit may further be configured to be coupled to the one or more spray guns to pressurize each spray gun during the cleaning operation, and the air circuit may preferably further include a gun pressure regulator to regulate gun pressure applied for pressurization of each spray gun. In this context, the control device may further include a first pressure sensor to measure the inlet pressure, a second pressure sensor to measure pressure of the compressed air delivered to the at least one pneumatically actuated pump, and a third pressure sensor to measure the gun pressure.

Lastly, the cleaning machine may further comprise an air blow system coupled to the air circuit to subject the one or more parts to a drying operation following the cleaning operation, in which case the air circuit further includes a second actuatable valve to control supply of compressed air to the air blow system. Additionally or alternatively, the cleaning machine may further comprise a manual air gun coupled to the air circuit to subject the one or more parts to a manual drying operation following the cleaning operation. In this context, the air circuit may further include a pressure sensor to measure pressure of the compressed air delivered to the air blow system and/or to the manual air gun. Further advantageous embodiments of the invention are discussed below.

### BRIEF DESCRIPTION OF THE DRAWINGS

Other features and advantages of the present invention will appear more clearly from reading the following detailed description of embodiments of the invention which are presented solely by way of non-restrictive examples and illustrated by the attached drawings in which:

FIG. 1 is a schematic perspective view of an industrial cleaning machine in accordance with an embodiment of the invention as used for cleaning one or more spray guns and accessories thereof;

FIG. 2 is a schematic functional diagram of the cleaning machine of FIG. 1 including a control device in accordance with a preferred embodiment of the invention;

FIG. 3 is a schematic functional diagram showing key components of the control device in accordance with a particularly preferred embodiment of the invention; and

FIG. 4 is a schematic functional diagram of an air circuit of the control device of FIG. 3.

### DETAILED DESCRIPTION OF EMBODIMENTS OF THE INVENTION

The present invention will be described in relation to various illustrative embodiments. It shall be understood that the scope of the invention encompasses all combinations and sub-combinations of the features of the embodiments disclosed herein, as reflected in the appended claims.

As described herein, when two or more parts or components are described as being connected, secured or coupled to one another, they can be so connected, secured or coupled directly to each other or through one or more intermediary parts.

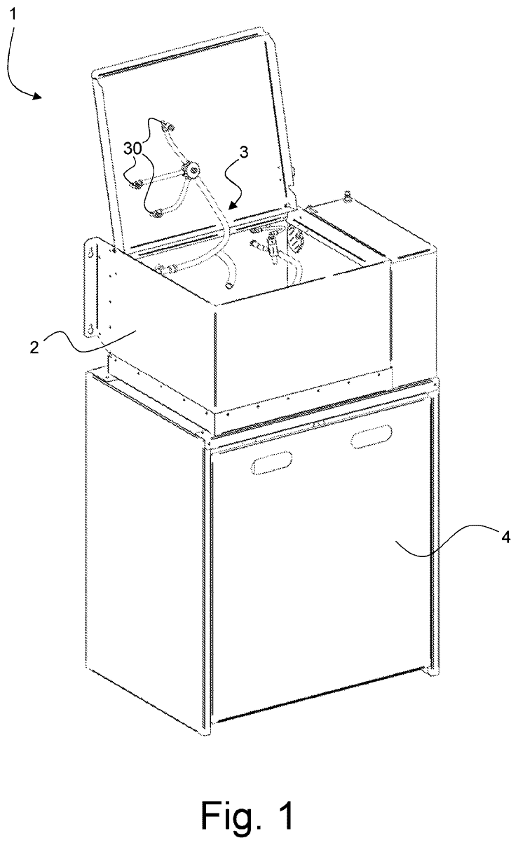

The invention will be described in relation to various embodiments of an industrial cleaning machine and associated control device as shown in FIGS. 1 to 4 that is used for the specific purpose of cleaning one or more spray guns and accessories thereof. The invention is however applicable to industrial cleaning of any other part that one wishes to subject to a cleaning operation using a cleaning liquid. The following embodiments of the invention may therefore be adapted to receive and clean any other part requiring cleaning.

In the context of the present invention, the expression “spray gun” is understood to refer to any type of spraying device as commonly used for spraying coating materials (paint, ink, varnish, etc.) onto a surface. Such spray guns conventionally employ compressed gas-usually compressed air-to atomize and project particles of the desired coating material onto the surface to be coated. Spray guns are for instance commonly used in paint shops for painting and coating bodywork parts and the like.

FIG. 1 is a schematic perspective view of an illustrative example of an industrial cleaning machine 1 in accordance with an embodiment of the invention. The cleaning machine 1 may take basically any adequate shape or configuration, the particular configuration shown in FIG. 1 being purely illustrative. As is conventional in the art, the cleaning machine 1 comprises at least one cleaning chamber 2 (more than one cleaning chamber being conceivable) capable of receiving one or more spray guns (not shown) that require cleaning, and a pneumatically operated cleaning system 3 capable of subjecting the one or more spray guns to a cleaning operation using a cleaning liquid. The cleaning system 3 typically includes at least one pneumatically actuated pump (not shown in FIG. 1) that is operated by compressed air supplied to the cleaning machine 1 to pump and supply cleaning liquid to a plurality of spray nozzles 30 that are positioned and adjusted to spray cleaning liquid onto the surfaces and portions of the spray guns that require cleaning. The cleaning process per se is preferably fully automatized or can be carried out partly or entirely by hand, depending on the functions implemented by the cleaning machine 1.

In the illustrated example, the cleaning chamber 2 is mounted on top of a cabinet 4 that is dimensioned to receive one or more containers (not shown) of cleaning liquid to be supplied to the cleaning system 3. Typically, at least a first container is provided with cleaning liquid that is made to recirculate back from the cleaning chamber 2 to the container. A further, separate container may be provided with fresh cleaning liquid that is used to ensure optimal cleaning of the spray gun(s). The cabinet 4 may potentially be omitted and the cleaning chamber 2 may alternatively be mounted directly onto a wall of the relevant workshop where the cleaning machine 1 is installed. The invention is not as such limited to any particular configuration of the cleaning machine 1.

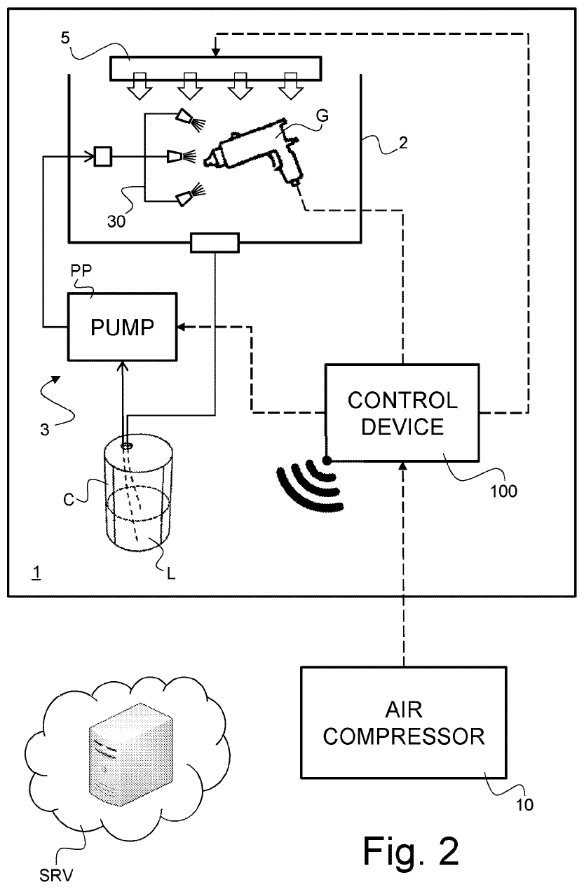

FIG. 2 is a schematic functional diagram of the cleaning machine 1 of FIG. 1, including a control device 100 thereof, in accordance with a preferred embodiment of the invention. Shown schematically in FIG. 2 is the cleaning chamber 2, a spray gun G that is suitably located and held in the cleaning chamber 2 by adequate mounting means (not shown), and the pneumatically operated cleaning system 3 and associated spray nozzles 30. Cleaning liquid L is supplied for spraying by the spray nozzles 30 by means of a suitable pneumatically operated cleaning liquid supply system, including at least one pneumatically actuated pump PP that is operated by compressed air supplied by an appropriate air compressor 10. The pump PP is operated to pump and supply cleaning liquid L from a cleaning liquid container C. In the illustrated example, cleaning liquid L supplied to the cleaning system 3 and sprayed onto the spray gun(s) G during the cleaning operation is collected at the bottom of the cleaning chamber 2 and recirculated back to the cleaning liquid container C. Cleaning liquid L is therefore recycled in the illustrated example. After a certain number of cleaning cycles, the cleaning liquid container C is typically replaced by a new container including fresh cleaning liquid L. As already mentioned above, a further, separate cleaning liquid container may be provided in addition to the cleaning liquid container C, including fresh cleaning liquid that is used to ensure optimal cleaning of the spray gun(s) G. In such case, a second pump is typically provided to pump and supply this fresh cleaning liquid. In other words, while a single pump PP and single cleaning liquid container C are shown in FIG. 2, two or more pumps and cleaning liquid containers could in effect be provided.

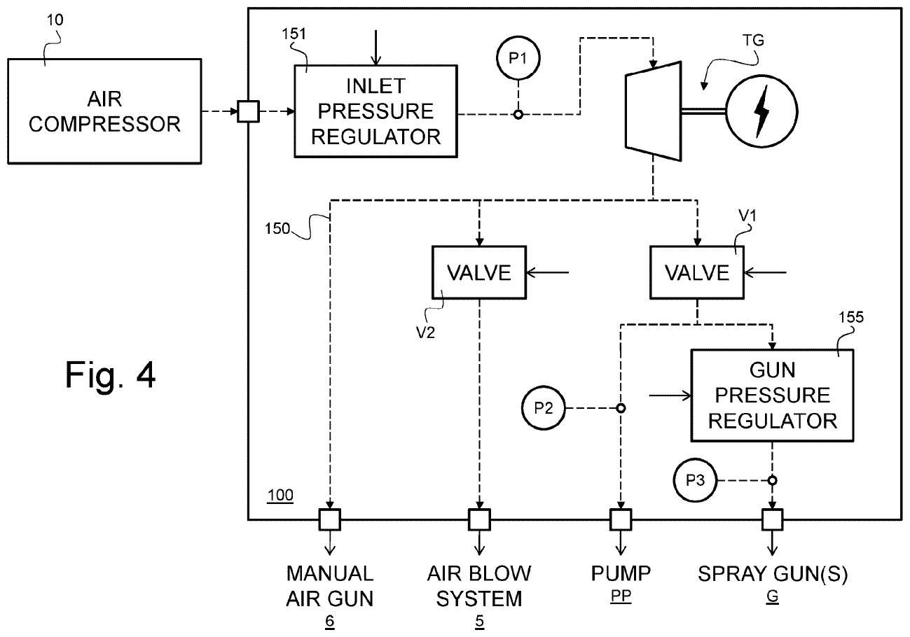

In accordance with the invention, a specific control device 100 is provided with a view to monitor and control operation of the cleaning machine 1. By way of preference, in the illustrated example, the control device 100 has two main functions, namely, (i) gather status information relating to operation of the cleaning machine 1 and communicate such status information to a remote server SRV, such as a cloud-based server, and (ii) control the supply of compressed air from the air compressor 10 to key components of the cleaning machine 1, including supply of compressed air to the pneumatically actuated pump PP. In the illustrated example, the control device 100 is also advantageously configured to pressurize the spray gun(s) G during the cleaning operation, as well as control supply of compressed air to an air blow system 5 that is used to subject the spray gun(s) G to a drying operation following the cleaning operation. While not shown, compressed air may alternatively or additionally be supplied to e.g. a manual air gun to subject the spray gun(s) G to a manual drying operation (see e.g. FIG. 4).

By way of preference, the control device 100 is fully housed in a dedicated casing that is attached to an appropriate hidden location of the cleaning machine 1 or to such a location of the cleaning machine 1 that is not easily accessible to the end user. The control device 100 may in particular be housed in a casing that can be attached to a rear portion of the cleaning machine 1. All key functional components of the control device 100 as described below are housed inside the casing, with the connections to the control device 100 essentially consisting of fittings to relevant air hoses (shown schematically as dashed lines in FIG. 2) for coupling to the pneumatically actuated pump PP, the spray gun(s) G, the air blow system 5, and any other pneumatically operated component of the cleaning machine 1, such as the aforementioned manual air gun. As this will be understood from reading the following description, the control device 100 is in essence autonomous and includes an air circuit that is configured to be coupled to a suitable air compressor 10, regular operation of the cleaning machine 1 being adequate to ensure self-sufficiency. More specifically, no connection to any external power source is required beyond connection to the air compressor 10. The control device 100 is meant to be designed to be fully compliant with the applicable directives governing equipment to be used in potentially explosive environments, such as the ATEX 114 Directive mentioned in the preamble.

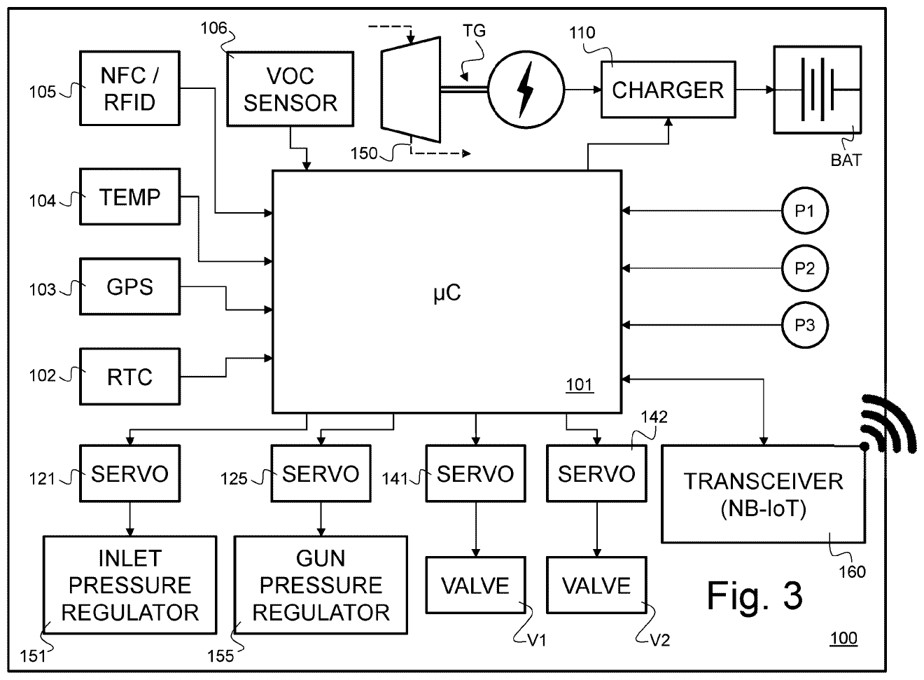

FIG. 3 is a schematic functional diagram showing key components of the control device 100 in accordance with a particularly preferred embodiment of the invention. The control device 100 includes a suitable microcontroller 101 (such as an ESP32 or Arduino microcontroller) handling all relevant functions of the control device 100, as well as a number of key components that are further described below. In the illustrated example, a real-time clock (RTC) 102 is provided to provide an adequate indication of the time and date, as well as a geolocalization device 103, such as a GPS receiver, to provide a geolocalization of the control device 100, and thus of the cleaning machine 1. A temperature sensor 104 is also provided to provide a measurement of ambient temperature, as well as a short-range communication device 105, such as an NFC (near-field communication) or RFID (radio-frequency identification) device, to allow short-range communication with an authorized service, including e.g. a computer, tablet or smartphone of an authorized operator/technician. Short-range communication may especially be established with the control device 100 via the NFC or RFID device 105 for the purpose of carrying out factory configuration and setting up of the control device 100 or on-site maintenance and troubleshooting thereof. By way of preference, the control device 100 further includes a VOC sensor 106 (such as an SGP30 sensor) to measure the presence of volatile organic compounds (VOC) in the environment of the cleaning machine 1, as well as possibly other constituents, such as CO₂ concentration. The measured concentration of volatile organic compounds (VOC) may be indicated to the end user and/or communicated to the remote server SRV. While not shown, one may for instance contemplate providing a series of LED indicators (e.g. green, yellow and red LEDs) located at an appropriate location of the cleaning machine 1 to provide a visual indication to the end user of the relevant level of volatile organic compounds measured in the environment. The provision of a suitable low power display could also be contemplated.

The control device 100 is configured to operate autonomously on power provided by a suitable battery BAT. In accordance with a particularly advantageous aspect of the invention, the battery BAT is rechargeable by means of a turbine generator TG that is operated by compressed air supplied to the cleaning machine 1. More specifically, the turbine generator TG forms part of the air circuit, designated by reference numeral 150, of the control device 100 (shown in greater detail in FIG. 4) and provides energy to the battery BAT via an adequate charger 110 that is controlled by the microcontroller 101 to ensure recharge of the battery BAT. For the sake of illustration, a turbine generator TG with a power generation capacity of approximately 150 mAh at 2 bar may be used, but higher capacities could be contemplated.

In the illustrated example, the control device 100 further includes four servo motors, including two servo motors 121, 125 that are associated to corresponding pressure regulators 151, 155, namely, an inlet pressure regulator 151 and a gun pressure regulator 155, and two further servo motors 141, 142 that are associated to two corresponding actuatable valves V1, V2. As this will be discussed in greater detail hereafter, the pressure regulators 151, 155 and actuatable valves V1, V2 form part of the air circuit 150 of the control device 100 and are controlled to ensure adequate supply of compressed air to relevant components of the cleaning machine 1. In the illustrated example, three pressure sensors P1, P2, P3 are further provided to provide the microcontroller 101 with adequate pressure measurements carried out at specified points of the air circuit 150.

The number of pressure regulators, valves, servo motors and pressure sensors could obviously be different in other embodiments, and the actual configuration of the air circuit of the control device will in effect be adapted to each applicable situation depending on the relevant configuration of the cleaning machine and functions that one wishes to implement. It will also be appreciated that operation of the air circuit and associated control elements could be performed in any adequate manner without departing from the scope of the appended claims and that e.g. the use of servo motors is purely illustrative. For instance, each pair of valve and associated servo motor V1/141 and V2/142 could in effect be replaced by suitable electrovalves.

Lastly, a transceiver device 160 is provided to allow wireless communication of data, including status information relating to operation of the cleaning machine 1, to the remote server SRV. The transceiver device 160 may be any adequate transceiver device. Ideally, the transceiver device 160 is based on the NB-IoT (Narrow-Band Internet of Things) standard. NB-IoT is a well-established low-power wide-area network (LPWAN) radio technology standard developed by the 3^{rd} Generation Partnership Project (3GPP) that allows direct communication of IoT devices over cellular networks with typically low power consumption requirements. Any other suitable LPWAN standard could however be contemplated, including e.g. the LTE-M/MTC (Machine Type Communication) standard, such as eMTC (enhanced Machine Type Communication). In other embodiments, the transceiver device 160 could be designed to allow wireless communication of data to a nearby WAN gateway, for instance via a suitable wireless local area network (WLAN), using standard wireless technology such the IEEE 802.11 standard or the Bluetooth® standard, in which case data are relayed by the WAN gateway for further communication to the remote SRV over e.g. the Internet.

Additional dedicated sensors (and/or sensor interfaces) could be provided to measure operational parameters of the cleaning machine 1 beyond the aforementioned pressure sensors P1, P2, P3. For instance, one or more flow rate sensors could be provided at one or more locations along the path of the cleaning liquid L with a view to measure a flow rate of the cleaning liquid L being pumped and supplied by the pneumatically actuated pump PP. Likewise a gauge sensor may be provided to measure the quantity of cleaning liquid being present in the cleaning liquid container C. It will be understood that such dedicated sensors are not necessarily integrated within the control device 100, but could be separate from the control device 100, in which case the control device 100 is provided with a corresponding sensor interface (or port) for connection to each relevant dedicated sensor.

FIG. 4 is a schematic functional diagram of the air circuit 150 of the control device 100 of FIG. 3. Also shown in FIG. 4 is the air compressor 10 providing a suitable supply of compressed air to the cleaning machine 1, which air compressor 10 is coupled to an inlet of the air circuit 150. The inlet pressure regulator 151 is provided at the inlet of the air circuit 150 to ensure that compressed air is supplied at an adequate and specified pressure of e.g. 7 bar. A first pressure sensor (or “inlet pressure sensor”) P1 is positioned immediately after the inlet pressure regulator 151 to measure inlet pressure. If the relevant pressure measurement exceeds the specified pressure, the inlet pressure regulator 151 is operated via the associated servo motor 121 to reduce inlet pressure. Conversely, if the relevant pressure measurement is lower than the specified pressure, the inlet pressure regulator 151 is operated to increase inlet pressure. If the specified inlet pressure cannot be reached, which may impact proper operation of the cleaning machine 1, a warning may be generated to advise the end user accordingly and/or communicate such information to the remote SRV to ensure that the end user is properly advised to take corrective measures.

In the illustrated example, the aforementioned turbine generator TG that is used to recharge the battery BAT of the control device 100 is located immediately after the inlet pressure regulator 151 and associated inlet pressure sensor P1. Downstream of the turbine generator TG, the air circuit 150 branches into three separate branches, namely, a first branch that is coupled inter alia to the pump PP, a second branch that is coupled to the air blow system 5, and a third branch that is coupled to a manual air gun 6. The first branch includes the first actuatable valve V1 which controls supply of compressed air to the aforementioned pneumatically actuated pump PP as well as pressurization of the spray gun(s) G. More specifically, in the illustrated example, downstream of the first actuatable valve V1, the first branch branches into two sub-branches, namely, a first sub-branch that is coupled to the pump PP and a second sub-branch that includes the gun pressure regulator 155 and is coupled to the relevant spray gun(s) G for pressurization thereof during the cleaning operation. A second pressure sensor (or “pump pressure sensor”) P2 is provided in the first sub-branch to measure pump pressure, and a third pressure sensor (or “gun pressure sensor”) P3 is provided in the second sub-branch, downstream of the gun pressure regulator 155, to measure pressurization of the spray gun(s) G. In the illustrated example, gun pressure regulator 155 is controlled in such a way that adequate pressurization of the spray gun(s) G is guaranteed during cleaning, i.e. such that a pressure of the order of e.g. 1 bar or slightly more is maintained in the inner air circuit of the spray gun(s) G to prevent penetration of cleaning liquid therein during the cleaning operation. As a result, considering an inlet pressure setting of 7 bar, compressed air is supplied to the pump PP at a pressure of the order of e.g. 6 bar in this example, which is normally sufficient to guarantee proper operation of the pump PP.

The second branch of the air circuit 150, downstream of the turbine generator TG, includes the second actuatable valve V2 which controls supply of compressed air to the aforementioned air blow system 5. In the illustrated example, the third branch of the air circuit 150, downstream of the turbine generator TG, is coupled to a manual air gun 6. While not shown, a third actuatable valve could be provided in the third branch to ensure that no compressed air is supplied to the manual air gun 6 while the pump PP or air blow system 5 is in operation. If necessary, a corresponding pressure sensor may also be provided in the second branch and/or third branch of the air circuit 150 to measure pressure of the compressed air delivered to the air blow system 5 and/or to the manual air gun 6.

Operation of the cleaning machine 1 and control device 100 will now be described in greater detail. For most of the time, when the cleaning machine 1 is not in operation, the control device 100 is switched to a low power consumption standby mode (or “sleep mode”) to minimize power consumption. By way of preference, the control device 100 is configured to turn on at least once a day to send status information to the remote server, including the geolocalization of the cleaning machine 1 and a state of charge of the battery BAT, as well as further status information relating to operation of the cleaning machine 1. The control device 100 and battery BAT are dimensioned to ensure that the control device 100 can remain in standby for a reasonably long duration without requiring any recharge, e.g. a couple of years or more.

During operation of the cleaning machine 1, the control device 100 will record the start of each cleaning cycle (time and date) and adjust pressure by operating the relevant pressure regulators 151, 155 as needed (e.g. 7 bar of inlet pressure, 1 bar in the spray gun(s) G and therefore 6 bar of pressure to the pump PP). Upon turning off the cleaning machine 1, the control device 100 records the overall cleaning time/duration and the number of spray guns G that have been cleaned. As a convention, a cleaning cycle that lasts more than one minute may be assumed to correspond to the cleaning of one spray gun G. Several counters may be provided including counters designed to count the number of cleaning cycles and the total number of cumulated hours of cleaning. Based on this information, one may also infer and make corresponding assumptions with regard to the consumption of cleaning liquid and relevant usage of cleaning liquid containers. In other words, recommendations can be sent to the end user with regard to the optimal time to perform replacement of used cleaning liquid by fresh cleaning liquid, thereby avoiding any damage to the pump or clogging of the cleaning liquid supply system.

Operation of the cleaning machine 1 may take place as follows:

### 1. Cleaning Cycle

Upon starting the cleaning machine 1 (e.g. by pressing a dedicated start/stop button, not shown), and assuming that the inlet pressure of the compressed air is adequate, servo motor 141 is operated to open the associated first valve V1 and thereby allow compressed air to circulate to the pump PP as well as pressurize the spray gun(s) G. For the duration of the cleaning cycle, which may take several minutes, the control device 100 performs simple checks to ensure that pressure in the air circuit 150 remains within relevant operative specifications, and records the duration of the relevant cleaning cycle until such cycle is completed (or interrupted). The control device 100 will especially read the pressure measurements provided by pressure sensors P1, P2 and/or P3 and make corresponding adjustments if need be.

At the end of the relevant cleaning cycle, servo motor 141 is actuated to close the associated valve V1. Such may be the case:
(a) in the event the predefined cleaning time has expired (normal condition);
(b) in the event the end user presses the start/stop button again (manual interruption); or
(c) in the event inlet pressure decreases below a specified threshold (abnormal/insufficient air supply).

By way of preference, once the cleaning cycle is completed, the control device 100 may retrieve the measurement of the concentration of volatile organic compounds (VOC) in the environment, as measured by the VOC sensor 106, and communicate and/or display such information to the end user.

While each cleaning cycle and operation of the control device 100 will lead to a corresponding power consumption, one will appreciate that the turbine generator TG is in effect in operation for the whole duration of the cleaning cycle, thus generating power that is used to recharge the battery BAT. In effect, the control device 100 is preferably designed in such a way as to ensure that the power generated by the turbine generator TG exceeds the relevant power consumption of the control device 100 during the cleaning cycle, allowing the battery BAT to be recharged during each cleaning cycle.

### 2. Drying Cycle

After completion of the cleaning cycle, and closure of the first actuatable valve V1, servo motor 142 is operated to open the associated second valve V2 and thereby allow compressed air to circulate to the air blow system 5, thereby initiating a drying cycle that may last approximately one minute. One will appreciate once again that the turbine generator TG will be in operation for the whole duration of the drying cycle, thus likewise generating power that is used to recharge the battery BAT. During the drying cycle, the control device 100 may basically be put on standby, until the drying cycle is completed, in order to reduce power consumption and ensure that the power generated by the turbine generator TG can optimally be exploited for the purpose of recharging the battery BAT. Optional use of the manual air gun 6 will likewise lead to operation of the turbine generator TG, providing additional power to recharge the battery BAT.

### 3. Communication Cycle

Once the drying cycle is completed, status information can be communicated to the remote server SVR using the transceiver device 160. Status information may include a unique IMEI (International Mobile Equipment Identity) number or like identification number assigned to the control device 100/cleaning machine 1, as well as any of the following information (the below list being non exhaustive):
number of cleaning cycles;
duration of each cleaning cycle;
start time (and date) of each cleaning cycle;
cumulated operating time;
pressure measurements;
geolocalization;
environmental measurements (such as VOC measurement, temperature, etc.);
estimated or actual consumption of cleaning liquid;
number of cleaning liquid containers used;
battery charge status; and
error/warning messages.

Status information may alternatively be communicated on a regular basis, e.g. once a day at a predefined time to save bandwidth and power. Communication of the status information after completion of each cleaning cycle may be advantageous in that such communication takes place almost in real time and is distributed over time. Communication of the status information may also be contemplated in response to a specific request sent by the remote server SRV.

### 4. Operational Controls (Pressure, Battery Charge Status, etc.)

Prior to putting the control device 100 in standby mode, it may be contemplated to check if the inlet pressure is correct and make corresponding adjustments in that regard if necessary. More specifically, depending on the pressure measurement provided by the first pressure sensor P1, the inlet pressure regulator 151 may be adjusted by means of the associated servo motor 121 to increase or decrease inlet pressure until the desired inlet pressure is reached. If no noticeable pressure increase is detected by the first pressure sensor P1, this can be regarded as being indicative of the fact that the maximum available output of the air compressor 10 has been reached. In such case, if inlet pressure is not sufficient to reliably operate the pump PP, an error/warning message may be generated to the end user. Such error/warning message may be communicated as part of the status information communicated to the remote server SRV, providing indication that the air compressor used by the end user does not meet the recommended requirements to reliably operate the cleaning machine 1 or that there is some other default in the supply of compressed air to the cleaning machine 1 (such as an air leak), which may require corrective actions.

It may also be worthwhile to regularly check and monitor the charge status of the battery BAT. For instance, if the battery charge status drops below a defined threshold, such as e.g. 40% of the battery capacity, the control device 100 may generate a warning message indicative of a low battery status and trigger an automatic recharge of the battery BAT at the end of the day using the turbine generator TG. For instance, the control device 100 may automatically wake up at a defined time, after typical working hours, and, provided a suitable supply of compressed air is available, may open the second actuatable valve V2 to force operation of the turbine generator TG and provide power to recharge the battery BAT. The second valve V2 may be closed as soon as the charge status of the battery BAT has reached a desired level or if inlet pressure drops below a minimum requirement to reliably operate the turbine generator TG. It is common for workshops to switch off the air compressor 10 after working hours and to allow the air compressor 10 to empty overnight. This being said, one may take advantage of the presence of residual compressed air remaining in the air compressor 10 for the purpose of recharging the battery BAT.

If the charge status of the battery BAT drops further below a defined threshold, e.g. 30% or lower of the battery capacity, an alarm message may be generated (and communicated to the remote server SRV) advising the end user that the turbine generator TG needs to be operated to recharge the battery BAT. In such case, the second valve V2 may be opened to operate the turbine generator TG for as long as necessary to partially or fully recharge the battery BAT.

Tests have been carried out by the Applicant using an industrial cleaning machine equipped with a prototype control device designed on the basis of the aforementioned principles. Power consumption of the control device in operation was measured at approximately 3 mA, with the turbine generator producing approximately 4.5 mA during the combined cleaning and drying cycles. The energy surplus was therefore estimated at about 1.5 mA. In the standby mode, power consumption of the control device was measured at approximately 0.05 mAh, i.e. 1.2 mA per day. Assuming that the control device is woken up once a day to carry out communication of the status information to the remote server, consuming 150 mAh for approximately 60 seconds, one can accordingly estimate that average daily power consumption of the control device in standby mode amounts to approximately 3.7 mA per day (or 88.8 mAh in the illustrative example). Continued operation of the control device in standby mode can be ensured for more than two years without recharge. Considering the aforementioned energy surplus ensured by the provision of the turbine generator, an average of three operative cycles (cleaning+drying) per day renders the control device self-sufficient. The aforementioned values are purely indicative and not meant to limit the applicable scope of the invention as defined by the appended claims.

Data sent to the remote server SRV may be processed in any appropriate manner using adequate software technology available in the art. A suitable application programming interface (API) may especially be designed in accordance with representational state transfer (REST) software guidelines which are employed throughout the software industry to create reliable web-based APIs. Data may be stored in any adequate database, such as an SQL database, enabling the running of data queries and processing of data to extract key information about the operation of the entire fleet of cleaning machines equipped with the control device of the invention.

On average, a total of 1′500 to 4′000 cleaning cycles are typically performed each year, meaning that the total number of data requests should not exceed 5′000 requests per year, per machine, which may amount to approximately 1 MB of data per year, per machine.

The invention also provides for the ability to possibly perform remote updates of operational parameters of the control device, including e.g. pressure settings for the inlet pressure, pump pressure and/or gun pressure. One may also contemplate to remotely update the duration of each cleaning cycle, depending on the efficiency of the cleaning liquid being used and make corresponding adjustments with regard to consumption of cleaning liquid and/or the number of cleaning cycles that can reliably be performed for a given quantity of fresh cleaning liquid. Other modifications could be undertaken remotely, including e.g. adjustments with regard to the relevant levels of concentration of volatile organic compounds (VOC) depending on the applicable local regulations. Any other desired update of the operational parameters of the control device could be contemplated, including firmware updates of components of the control device.

As a further refinement, one may contemplate to further configure the control device to locally record data relating to operation of the cleaning machine in non-volatile memory, such as in an EPROM, to ensure that such data can be retrieved even in the event of a complete shutdown or failure of the control device.

Failsafe measures could also be implemented to ensure that operation of the cleaning machine is deactivated in the event the cleaning machine is operated outside of acceptable operative conditions/specifications, requiring on-site intervention by an authorized operator/technician. Complete shutdown of the cleaning machine may also be contemplated if no connection to the remote server can be established for a given duration.

Various modifications and/or improvements may be made to the above-described embodiments without departing from the scope of the invention as defined by the appended claims.

For instance, referring to the embodiment shown in FIG. 4, instead of providing a pressure regulator to regulate gun pressurization, a relevant pressure regulator may be provided in the other sub-branch that is coupled to the pump to regulate the pump pressure.

Furthermore, as mentioned above, more than one pneumatically actuated pump could be contemplated to pump and supply different cleaning liquids from multiple containers. In such case, corresponding valves, servo motors and, if necessary, pressure regulators (or any other adequate means) may be provided to similarly control supply of compressed air to each pump and adjust the relevant pump pressure.

In addition, while FIG. 4 shows the turbine generator TG positioned in-line with the pneumatically-actuated pump PP (and other pneumatic components of the cleaning machine), one could perfectly contemplate to position the turbine generator TG in a dedicated branch of the air-circuit so as to be selectively drivable by a supply of air from the air compressor 10, independently of the pneumatic operation of the pump PP or other pneumatic components of the system. In effect, the configuration of the air circuit of the control device may differ from the particular configuration depicted e.g. in FIG. 4 and the turbine generator TG may be positioned at any suitable location of the relevant air circuit to provide for the ability to recharge the battery.

Lastly, while FIGS. 3 and 4 show three pressure sensors for providing pressure measurements carried out at specified points of the air circuit of the control device, other dedicated sensors could be provided in addition to or in lieu of the relevant pressure sensors to measure operational parameters of the cleaning machine. Such dedicated sensors may indifferently be integrated within the control device itself or be distributed at key locations of the cleaning machine where the relevant measurements are to be carried out. In the latter case, the control device will be provided with a suitable sensor interface for connection to each dedicated sensor that is not integrated within the control device.

### LIST OF REFERENCE NUMERALS AND SIGNS USED THEREIN

1 cleaning machine
2 cleaning chamber
3 pneumatically operated cleaning system
30 cleaning/spraying nozzles
4 cabinet
5 air blow system (post-cleaning drying)
6 manual air gun (post-cleaning drying)
10 air compressor
100 control device
101 microcontroller
102 real-time clock (RTC)
103 GPS receiver (geolocalization device)
104 temperature sensor
105 short-range communication device (e.g. NFC device or RFID device)
106 VOC (volatile organic compounds) sensor
110 battery charger
121 (first) servo motor (inlet pressure regulation)
125 (second) servo motor (gun pressure regulation)
141 (third) servo motor (actuation of first valve V1)
142 (fourth) servo motor (actuation of second valve V2)
150 air circuit
151 inlet pressure regulator
155 gun pressure regulator
160 long-range transceiver for communication with remote server SRV (e.g.
NB-IoT transceiver)
G spray gun
C cleaning liquid container
L cleaning liquid
PP pneumatically actuated pump
TG turbine generator
BAT rechargeable battery
V1 (first) actuatable valve (control of compressed air supply to pump PP/gun pressurization)
V2 (second) actuatable valve (control of compressed air supply to air blow system 5)
P1 (first) pressure sensor (inlet pressure measurement)
P2 (second) pressure sensor (pump pressure measurement)
P3 (third) pressure sensor (gun pressure measurement)
SRV remote server for data collection (e.g. cloud server)

1.-19. (canceled)

20. An industrial cleaning machine for cleaning parts comprising at least one cleaning chamber capable of receiving one or more parts requiring cleaning, and a pneumatically operated cleaning system capable of subjecting the one or more parts to a cleaning operation using a cleaning liquid,
wherein the pneumatically operated cleaning system includes at least one pneumatically actuated pump that is operated by compressed air supplied to the cleaning machine to pump and supply the cleaning liquid from a cleaning liquid container,
wherein the cleaning machine integrates a control device configured to monitor and control operation of the cleaning machine and to operate autonomously on power provided by a battery,
wherein the control device is configured to gather status information relating to operation of the cleaning machine and communicate the status information to a remote server,
and wherein the control device includes an air circuit that is configured to be coupled to an air compressor to control supply of the compressed air to the at least one pneumatically actuated pump.

21. The cleaning machine according to claim 20, wherein the status information includes operational parameters of the cleaning machine and of the control device.

22. The cleaning machine according to claim 21, wherein the operational parameters of the cleaning machine and of the control device include any one of the following:
a number of cleaning cycles performed by the cleaning machine;
a start time of each cleaning cycle performed by the cleaning machine;
a duration of each cleaning cycle performed by the cleaning machine;
a number of parts subjected to the cleaning operation;
a consumption of the cleaning liquid;
pressure parameters measured by the control device;
environmental parameters measured by the control device; and
warning or error messages generated by the control device.

23. The cleaning machine according to claim 20, wherein the control device includes a transceiver configured to wirelessly communicate the status information to the remote server.

24. The cleaning machine according to claim 23, wherein the transceiver is a transceiver operating according to a LPWAN (low-power wide area network) radio technology standard.

25. The cleaning machine according to claim 24, wherein the transceiver operates according to the NB-IoT (Narrow-Band Internet of Things) standard.

26. The cleaning machine according to claim 23, wherein the transceiver is further configured to receive data from the remote server to update operational settings of the cleaning machine and/or of the control device.

27. The cleaning machine according to claim 20, wherein the control device includes a geolocalization device to provide a geolocalization of the cleaning machine,
and wherein the status information communicated to the remote server includes the geolocalization of the cleaning machine.

28. The cleaning machine according to claim 20, wherein the control device includes:
a sensor to measure quality of air in the environment of the cleaning machine; and/or
a temperature sensor to measure the temperature of the environment of the cleaning machine.

29. The cleaning machine according to claim 28, wherein the sensor to measure quality of air in the environment of the cleaning machine is a sensor to measure the presence of volatile organic compounds (VOC) in the environment of the cleaning machine.

30. The cleaning machine according to claim 28, wherein the status information communicated to the remote server includes environmental data relating to the quality of the air measured in the environment of the cleaning machine and/or to the measured temperature of the environment of the cleaning machine.

31. The cleaning machine according to claim 20, wherein the control device includes one or more dedicated sensors and/or one or more sensor interfaces for connection to a corresponding number of dedicated sensors to measure operational parameters of the cleaning machine.

32. The cleaning machine according to claim 31, wherein the one or more dedicated sensors include any one of the following:
pressure sensors to measure pressure of compressed air supplied to the cleaning machine or to components of the cleaning machine;
flow rate sensors to measure a flow rate of the cleaning liquid supplied by the pneumatically operated cleaning system; and
gauge sensors to measure a quantity of the cleaning liquid.

33. The cleaning machine according to claim 20, wherein the battery is rechargeable by means of a turbine generator that forms part of the air circuit and is operated by the compressed air supplied to the cleaning machine.

34. An industrial cleaning machine for cleaning parts comprising at least one cleaning chamber capable of receiving one or more parts requiring cleaning, and a pneumatically operated cleaning system capable of subjecting the one or more parts to a cleaning operation using a cleaning liquid,
wherein the pneumatically operated cleaning system includes at least one pneumatically actuated pump that is operated by compressed air supplied to the cleaning machine to pump and supply the cleaning liquid from a cleaning liquid container,
wherein the cleaning machine integrates a control device configured to monitor and control operation of the cleaning machine and to operate autonomously on power provided by a battery,
wherein the control device includes an air circuit that is configured to be coupled to an air compressor to control supply of the compressed air to the at least one pneumatically actuated pump,
and wherein the battery is rechargeable by means of a turbine generator that forms part of the air circuit and is operated by the compressed air supplied to the cleaning machine.

35. The cleaning machine according to claim 34, wherein the control device is configured to automatically switch to a low power consumption standby mode when no compressed air is supplied to the cleaning machine and to automatically switch to an operative mode when compressed air is supplied to the cleaning machine.

36. The cleaning machine according to claim 35, wherein the control device is configured to periodically wake up from the low power consumption standby mode to check a charge status of the battery.

37. The cleaning machine according to claim 36, wherein the control device is configured to generate a warning or error message in case a charge status of the battery drops below a defined threshold and/or to force supply of compressed air to the turbine generator in case a charge status of the battery drops below the defined threshold.

38. The cleaning machine according to claim 34, wherein the air circuit includes an inlet pressure regulator to regulate inlet pressure of the compressed air at an inlet of the air circuit and a first actuatable valve to control supply of compressed air to the at least one pneumatically actuated pump.

39. The cleaning machine according to claim 38, wherein the one or more parts requiring cleaning include one or more spray guns,
and wherein the air circuit is configured to be coupled to the one or more spray guns to pressurize each spray gun during the cleaning operation.

40. The cleaning machine according to claim 39, wherein the air circuit further includes a gun pressure regulator to regulate gun pressure applied for pressurization of each spray gun.

41. The cleaning machine according to claim 40, wherein the control device further includes:
a first pressure sensor to measure the inlet pressure;
a second pressure sensor to measure pressure of the compressed air delivered to the at least one pneumatically actuated pump; and
a third pressure sensor to measure the gun pressure.

42. The cleaning machine according to claim 38, further comprising an air blow system coupled to the air circuit to subject the one or more parts to a drying operation following the cleaning operation, wherein the air circuit further includes a second actuatable valve to control supply of compressed air to the air blow system, and/or
wherein the cleaning machine further comprises a manual air gun coupled to the air circuit to subject the one or more parts to a manual drying operation following the cleaning operation.

43. The cleaning machine according to claim 42, wherein the air circuit further includes a pressure sensor to measure pressure of the compressed air delivered to the air blow system and/or to the manual air gun.
